(19) United States
(12) Patent Application Publication
(10) Pub. No.: US 2025/0154626 A1
(43) Pub. Date: May 15, 2025

(54) Processing of Black Mass

(71) Applicant: Volkswagen Aktiengesellschaft, Wolfsburg (DE)

(72) Inventors: Martin Gallenkemper, Braunschweig (DE); Alexander Reitzle, Neu-Ulm (DE); Klaus Stefan Klimek, Bovenden (DE)

(73) Assignee: Volkswagen Aktiengesellschaft, Wolfsburg (DE)

(21) Appl. No.: 18/943,040

(22) Filed: Nov. 11, 2024

(30) Foreign Application Priority Data
Nov. 10, 2023 (DE) 10 2023 211 159.4

(51) Int. Cl. C22B 7/00; C22B 1/00; C22B 3/22; H01M 10/54

(52) U.S. Cl. CPC C22B 7/008; C22B 1/005; C22B 3/22; H01M 10/54

(57) ABSTRACT

Described herein is a method for purifying black mass of a battery, comprising providing processed cathode or anode black mass, and bringing processed black mass into contact with a basic mixture, wherein the basic mixture comprises at least one alcohol and at least one alkoxide.

### CROSS-REFERENCE TO RELATED APPLICATIONS

This application claims priority to German Patent Application No. DE 10 2023 211 159.4, filed on Nov. 10, 2023 with the German Patent and Trademark Office. The contents of the aforesaid Patent Application are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The disclosure relates to a method for purifying black mass and the use of a basic mixture for purifying black mass.

As part of sustainable use of raw materials, recycling is gaining greater and greater significance. Typical (thermo) mechanical recycling processes often lead to too much contamination. For example, when directly recycling NMC (nickel-manganese-cobalt mixed oxide) cathode product rejects from battery cell production, there is too much aluminum. Through the combination of various processes (thermal, wet and dry mechanical), typically an insufficient quality (purity of the reusable material, too high aluminum contents) is achieved.

In EOL (end-of-life) recycling of batteries, there are solvent extraction methods that extract individual metals as reusable material.

### SUMMARY

A need exists to provide a method for purifying black mass and a basic mixture for purifying black mass that at least partially overcome the aforementioned disadvantages.

The need is addressed by the subject matter of the independent claim(s). Embodiments of the invention are described in the dependent claims, the following description, and the drawings.

### BRIEF DESCRIPTION OF THE DRAWINGS

FIG. 1 schematically shows a method according to some embodiments;

FIG. 2 schematically shows a method according to some embodiments; and

FIG. 3 schematically shows a method according to some embodiments.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other: instances, well-known features have not been described in detail to avoid unnecessarily complicating the instant description.

In some embodiments, a method for purifying black mass of a battery is provided, wherein the method comprises:
Providing processed black mass,
Bringing processed black mass into contact with a basic mixture, wherein the basic mixture comprises at least one alcohol and at least one alkoxide.

Black mass of a battery is an electrochemically active layer having a wide variety of metals, such as lithium, manganese, copper, nickel, cobalt, etc. In a cathode, the black mass is aluminum foil, on which a layer of NMC (nickel-manganese-cobalt mixed oxide), binders, conductive additives, etc. may be applied. The NMC can be replaced by other active materials such as, e.g., iron phosphate, nickel-cobalt-aluminum oxide, or sulfur compounds. Lithium can be used as an additional cation. In an anode, the black mass is largely graphite with binders and conductive additives. In addition, black mass can comprise silicon, graphene, and/or lithium titanium dioxide. In general, most of the active materials are doped with additional metals.

The present case may be black mass of a cathode, or may be black mass of an anode. In some embodiments, it may also be a mixture of black mass of a cathode and black mass of an anode or other mixtures.

The black mass may originate from a scrap stream, i.e., a stream of reusable material, and a targeted treatment of these streams can be performed. For each processing, it may be beneficial if the material streams are separated out in advance. For example, it may be beneficial for the anode since it can be adapted in a targeted manner to the foils of the anode, e.g., copper foil, and their residues can be avoided and removed in a targeted manner through (thermo) mechanical treatment and thus a considerably less contaminated black mass may be generated. Thus, selective removal of contaminants, e.g., copper, can also be possible on the anode side due to the relatively inert active material and the ability to use aqueous systems, and separating out aluminum may not be necessary at all due to the purity of the materials.

A method according to some embodiments comprises providing processed black mass, for example black mass of high purity, e.g., by using pure input streams (for example, material streams from production rejects or from a presorting can be used). High purity is understood to mean, for example, a contamination of the black mass of at most 2000 ppm, or at most 500 ppm, or at most 20 ppm in some embodiments. The processing may be various mechanical and/or chemical methods. In some embodiments, the processing may be a mechanical comminution of production rejects/scrap to form black mass. The mechanical comminution may comprise shredding, cutting, grinding, electrohydraulic fragmentation, de-agglomeration, or other comminution processes.

The chemical processing may be treatment with suitable chemicals, such as organic or inorganic acids or bases, in some embodiments.

It is also conceivable in some embodiments for thermal processing to take place additionally or alternatively to the mechanical or chemical processing.

The mechanically and/or chemically and/or thermally treated black mass may in some embodiments also be divided into fractions of various particle sizes. Additionally or alternatively and in some embodiments, individual particles can also be separated out.

For example, the black mass may be processed into a powdered material. For example, the processed black mass may be a pure powdered cathode material.

In some embodiments, the processed black mass is brought into contact with a basic mixture, wherein the basic mixture comprises at least one alcohol and at least one alkoxide.

In some embodiments, the at least one alcohol is an alcohol selected from a C₃-C₈ alcohol. For example, the at least one alcohol is an alcohol selected from a C₃-C₆ alcohol. The at least one alcohol can be selected from the group consisting of propanol, isopropanol, n-butanol, and pentanol and hexanol isomers in some embodiments.

The at least one alcohol is for example n-butanol.

The at least one alcohol may also be a mixture of at least two alcohols in some embodiments. The at least one alcohol may also be a mixture of at least one alcohol (e.g., C₃-C₈ alcohol) and water in some embodiments.

The basic mixture also comprises at least one alkoxide. In some embodiments, the alkoxide is an alkali metal alkoxide or a transition metal alkoxide. The alkoxide may also be an alkaline earth alkoxide in some embodiments.

An alkali metal alkoxide may for example be selected from the group consisting of Li-alkoxide, Na-alkoxide, and potassium alkoxide. In some embodiments, the alkali metal alkoxide is Li-alkoxide.

A transition metal alkoxide may be selected from the group consisting of Fe-alkoxide, Ni-alkoxide, and Cr-alkoxide in some embodiments.

The at least one alkali metal alkoxide or transition metal alkoxide may also be a mixture of at least two alkoxides in some embodiments.

For example, the alkoxide is chosen in order to match the at least one alcohol used. For example, the alcohol may be butanol and the alkoxide may be a butoxide.

For example, the basic mixture may comprise isopropanol and Li-isopropoxide. Alternatively, the basic mixture may comprise tert-butanol and lithium tert-butoxide.

The at least one alcohol and the at least one alkoxide may be present in a specific ratio. The at least one alcohol and the at least one alkoxide may be in a ratio for example in the range from 99:1 to 8:2, or in the range from 99:1 to 9:1, or in the range from 98:2 to 95:5 in some embodiments.

In some embodiments, the basic mixture has a pH value in the range of greater than 7.5. In some embodiments, the basic mixture has a pH value in the range from 8 to 14, and in some embodiments, the basic mixture has a pH value in the range from 9 to 12. The basic mixture may also have further constituents. The basic mixture may have complexing agents or other auxiliary materials. For example, the basic mixture may have complexing agents for various metals, e.g., aluminum complexing agents.

By bringing the processed black mass into contact with the basic mixture, constituents of the black mass, such as aluminum and/or oxidized aluminum, may be selectively separated out. Aluminum may form an amphoteric aluminum with the basic mixture and thus be separated out of the processed black mass. Through the formation of amphoteric aluminum, even small amounts of aluminum may be separated out, thus purifying the processed black mass. For example, no further components of the black mass are affected or, respectively, destroyed by the basic mixture; for example, the particle structure of components such as NMC (nickel-manganese-cobalt mixed oxide) is not affected.

Separated-out components such as, e.g., aluminum, may be fed to further processing or, respectively, recycling and thus be returned to a material cycle in some embodiments.

The black mass may be dry black mass in some embodiments. Dry black mass from battery recycling does not comprise any liquid constituents such as electrolytes or liquid battery slurry. Rather, dry black mass can be coated coils, crumpled material from malfunctions, individual sheets or stacked material, which is sorted out again (separation of cathode, anode, separator, auxiliary materials) and may have been previously removed from a housing (solid or pouch). Dry black mass can originate in particular from production rejects.

The black mass may also be wet black mass in some embodiments. Wet black mass from battery recycling comprises liquid constituents such as, for example, electrolytes or liquid battery slurry. Wet black mass may originate from defective batteries, battery material from the mixing and coating method, or batteries that have reached the end of their service life.

If wet black mass is used, it may be wet-crushed together with the basic mixture and utilized further in the method in this state.

The method may also comprise a mechanical separation of the black mass and the basic mixture. The mechanical separation may be filtration, screening, sedimentation, centrifugation, or other mechanical separation processes. The separation may be carried out, for example, by means of a screen, decanter, filter, etc.

The separated-out black mass may be further purified. The further purification may be performed by washing or, respectively, repeated washing with suitable solvents or even with the basic mixture. The washed black mass may then be freed of the solvent or, respectively, the basic mixture. This may be carried out by drying at increased temperatures, by applying a stream of dry air or inert gas, or by washing with solvents that are beneficial for the further processing of the black mass (e.g., NMP). Solvent recovery may be included in this process.

The use of a basic mixture comprising at least one alcohol and at least one alkoxide for a method of purifying black mass is also the subject matter of the teachings herein. The black mass may for example be dry black mass as described herein. In some embodiments, it can be wet black mass as described herein.

The basic mixture, the at least one alcohol, and the at least one alkoxide can be the basic mixture, the alcohol, or, respectively, the alkoxide as described herein. The basic mixture for example comprises at least one Li-alkoxide. The Li-alkoxide may be an Li-alkoxide as described herein.

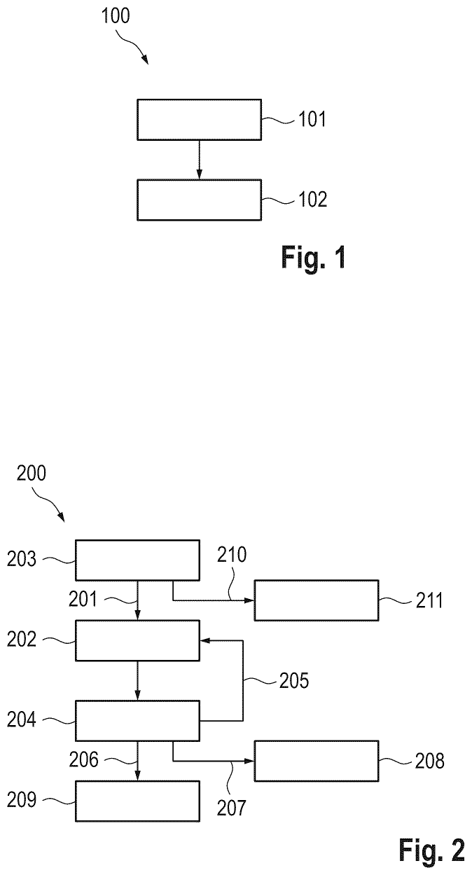

An embodiment of a method 100 is shown in FIG. 1. The method for purifying black mass of a battery 100 comprises the steps 101, in which processed black mass is made available. Then the processed black mass is brought into contact 102 with a basic mixture, wherein the basic mixture comprises at least one alcohol and at least one alkoxide.

FIG. 2 shows a further embodiment of a method for purifying black mass of a battery 200. Initially, conventional black mass extraction 203 can take place. The conventional black mass extraction 203 can be a dry mechanical delamination. If necessary, thermal processing and/or dry separation can also take place during conventional black mass extraction 203. Through the conventional black mass extraction 203, processed black mass 201 and residues 210, such as aluminum foil, can be extracted.

Residues 210 such as aluminum foil can be fed to aluminum recycling 211. The processed black mass 201 can then be brought into contact 202 with a basic mixture and thus form a slurry. The basic mixture here comprises at least one alcohol and at least one alkoxide (e.g., Li-alkoxide). This allows the aluminum that is still present in the black mass to be selectively dissolved. Then, a mechanical separation 204 can occur by removing the contaminated solvent, for example, by filtering, decanting, etc. The separated-out solid material can be cleaned by washing 205 and can be brought into contact 202 again with the basic mixture. The solid material 206 extracted from the separation 204 is processed black mass. The liquid 207 extracted from the separation 204 is the at least one alcohol, the at least one alkoxide, and the at least one aluminum ion or the at least one aluminum complex. The at least one alcohol, the at least one alkoxide, and the aluminum ion or, respectively, the aluminum complex can be fed to a regeneration 208. In this case, the at least one alcohol, the at least one alkoxide, and/or the aluminum ion or, respectively, the aluminum complex can be reprocessed and reused. Then, residual moisture can be removed 209 and thus, for example, solvent that cannot be reused can be removed. Removing the residual moisture 209 can be carried out by drying and/or washing with a suitable solvent (e.g., NMP).

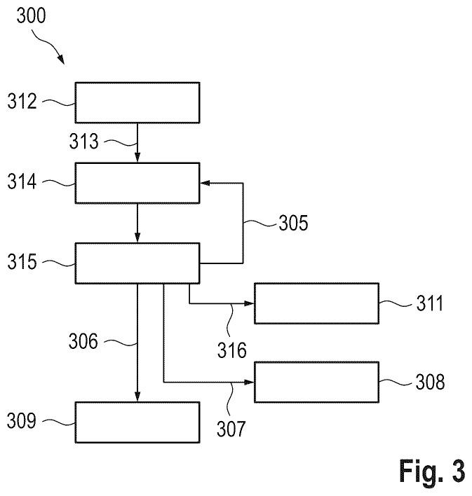

FIG. 3 shows a further embodiment of a method for purifying black mass of a battery 300. Initially, conventional precomminution of battery material 312 can be carried out. The conventional precomminution can be carried out by a shredder or a granulator. The comminuted material 313 can then be fed to wet grinding 314. There, the comminuted material 313 is wet-crushed with at least one alcohol and at least one alkoxide (e.g., Li-alkoxide). In the process, delamination and dissolution of the present aluminum occurs in parallel. In a further step, a multi-stage mechanical separation 315 of liquid, foil, black mass, and possibly present grinding media can be carried out. The mechanically separated material may be washed 305 and returned to the wet grinding 314. Through the mechanical separation 315, solid material 306, i.e., processed black mass, liquid 307, such as the at least one alcohol, the at least one aluminum alkoxide, or an aluminum complex and aluminum foil 316 can thus be extracted. The aluminum foil can be fed to aluminum recycling 311. The at least one alcohol, the at least one alkoxide, and the aluminum can be fed to a regeneration 308. In this case, the at least one alcohol, the at least one alkoxide, and/or the aluminum can be reprocessed and reused. Then, residual moisture can be removed 309 and thus, for example, solvent that cannot be reused can be removed. Removing the residual moisture 309 can be carried out by drying and/or washing with a suitable solvent (e.g., NMP).

Example: Processing cathode black mass after a simple mechanical process for black mass extraction
1. Shredding the cathode foil
2. Possible pyrolysis at 500° C. with 1 h dwell time
3. Hammer mill (screen width 5 mm)
4. Screening with vibration screen (125 μm)
5. Addition of the fine fraction (approx. 100 g) to a mixing vessel with 1000 g of isopropanol and 50 g of Li-isopropoxide dissolved in the alcohol.
6. 45 minutes of mixing to dissolve aluminum contaminants
7. Filtering (5 μm)
8. Solid material: Addition to mixing vessel with 1000 g of isopropanol and 10 g of Li-isopropoxide dissolved in the alcohol.
9. Filtering 5 μm
10. Drying solid material in drying cabinet at 85° C.
11. Checking the contamination with IPC

### LIST OF REFERENCE NUMERALS

100, 200, 300 Method for purifying black mass
101, 201 Providing processed black mass
102, 202 Bringing processed black mass into contact with a basic mixture
203 Conventional black mass extraction
204 Mechanical separation
205, 305 Washing
206, 306 Solid material
207, 307 Liquid
208, 308 Regeneration
209, 309 Removing residual moisture
210 Residues
211, 311 Aluminum recycling
312 Precomminution of battery material
313 Comminuted material
314 Wet grinding
315 Mechanical separation
316 Aluminum foil

The invention has been described in the preceding using various exemplary embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, module or other unit or device may fulfil the functions of several items recited in the claims.

The term “exemplary” used throughout the specification means “serving as an example, instance, or exemplification” and does not mean “preferred” or “having advantages” over other embodiments. The term “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

1. A method for purifying black mass of a battery, comprising:
providing processed cathode or anode black mass; and
bringing processed black mass into contact with a basic mixture; wherein
the basic mixture comprises at least one alcohol and at least one alkoxide.

2. The method of claim 1, wherein the at least one alcohol is a C₃-C₈ alcohol.

3. The method of claim 1, wherein the at least one alkoxide is an alkali metal alkoxide or a transition metal alkoxide.

4. The method of claim 1, wherein the at least one alkoxide is a Li-alkoxide.

5. The method of claim 1, wherein the basic mixture has a pH value in the range of greater than 7.5.

6. The method of claim 1, wherein the ratio of the at least one alcohol to the at least one alkoxide is in the range from 99:1 to 8:2.

7. The method of claim 1, wherein the black mass is dry black mass.

8. The method of claim 1, wherein the processed black mass and the basic mixture are wet-crushed together.

9. The method of claim 1, further comprising a mechanical separation of the black mass and the basic mixture.

10. A method of utilizing a basic mixture comprising at least one alcohol and at least one alkoxide for purifying black mass.

11. The method of claim 10, wherein the basic mixture comprises at least one Li-alkoxide.

12. The method of claim 10, wherein the at least one alkoxide is an alkali metal alkoxide or a transition metal alkoxide.

13. The method of claim 10, wherein the at least one alkoxide is a Li-alkoxide.

14. The method of claim 10, wherein the basic mixture has a pH value in the range of greater than 7.5.

15. The method of claim 10, wherein the ratio of the at least one alcohol to the at least one alkoxide is in the range from 99:1 to 8:2.

16. The method of claim 10, wherein the black mass is dry black mass.

17. The method of claim 10, wherein the processed black mass and the basic mixture are wet-crushed together.

18. The method of claim 10, further comprising a mechanical separation of the black mass and the basic mixture.

19. The method of claim 10, wherein the black mass is processed cathode or anode black mass.
